(19) United States
(12) Patent Application Publication
(10) Pub. No.: US 2007/0057503 A1
(43) Pub. Date: Mar. 15, 2007

(54) Irrigation connectors

(76) Inventor: Stanley E Hawkins, (US)

Correspondence Address: MYERS DAWES ANDRAS & SHERMAN, LLP, 19900 MACARTHUR BLVD.,, SUITE 1150, IRVINE, CA, 92612, US

(21) Appl. No.: 10/524,446

(22) PCT Filed: Feb. 7, 2003
(86) PCT No.: PCT/US03/03605

§ 371 Date: Oct. 31, 2006

(51) Int. Cl. F16L 39/00

(52) U.S. Cl. 285/133.11

(57) ABSTRACT

An inventory of connectors or fittings for agricultural and landscape irrigation applications and method that simplifies the manufacturing process by designing the connectors so that they share basic common body parts (210,310). The parts are manufactured individually by injection molding and assembled using sonic welding. The common body parts shared greatly minimize the number of molds necessary to manufacture a complete line of fittings.

### BACKGROUND OF THE INVENTION

1. Field of the Invention

The invention relates generally to irrigation tubing fittings suitable for landscape and agricultural applications, and more particularly to an inventory of irrigation fittings that feature a variety of connection types and sizes while sharing basic body parts.

2. Description of the Prior Art

Irrigation connectors for agricultural and landscape use are commonly made of injection molded plastic parts. Couplings are a common example of such fittings that connect two similar sized pieces of tubing. Tubing used in irrigation applications is typically flexible and made from polyethylene or vinyl with minimum wall thickness, and may be termed poly drip tubing. Still thinner walled irrigation tape is used in irrigation low-pressure applications.

Adapters are another common example of fittings used for irrigation and landscape applications that permit transitions from various threaded or glued pipe, tubing or hose ends to commonly used drip connections. Examples include a ½ inch or a ¾ inch MPT (male pipe thread) Adapter which will have threads at the inlet end and a tubing fitting at the outlet end. Different types of adapters will vary in inlet thread types and tubing outlet size. Tees and 90 degree elbows are also fittings that may have tubing fittings at the inlet and outlet or may have various threaded inlets with tubing outlets.

Heretofore, irrigation fitting manufacturing practice has involved injection molding each particular fitting required with a multi-cavity tool. Hence, each fitting requires its own dedicated multi-cavity tool for manufacturing. The following are just some examples of fittings that requires a dedicated multi-cavity tool for manufacturing the part: tubing coupling, ½ inch MPT with tubing outlet, ¾ inch MPT with tubing outlet, ¾ inch MHT (male hose thread) with tubing outlet, 90 degree elbow with tubing inlet and outlet, 90 degree elbow with ¾ inch MHT inlet and tubing outlet, tee with tubing inlet and tubing outlet, and tee with ¾ inch MHT inlet and tubing outlet. Expanding on the various fitting combinations are the different styles of essentially the same fitting. For example, there are compression type fittings suitable for higher pressure applications, and insert type fittings used in low pressure drip applications.

Additionally, Agricultural Products Inc. (API), the assignee of this application has developed different styles of connectors or fittings to further add to the variations of complete fittings. For example, API developed the widely used Spin Loc® Fittings that are reusable, glass reinforced fittings that fit and lock onto drip tubing. These fittings contain a locking sleeve or ring for a secure connection. Another fitting style developed by API is the Tape Loc® Fittings that are specially designed for use with thin-wall trickle tapes.

As previously stated, current manufacturing practice involves injection molding each particular fitting required with a dedicated, complex multi-cavity tool. Therefore a need exists to simplify the current manufacturing process so that a wide variety of distinct fittings can be manufactured without the increased cost of additional molding presses and complex multi-cavity tools. In light of this problem, it is an object of the present invention to provide an inventory of irrigation connectors or fittings that feature a variety of connection types and sizes while sharing common basic body parts. It is further an object of the present invention to provide a method of assembling a wide variety of finished connectors from a relatively low number of individual parts using sonic welding. Yet another object of the present invention is to provide an apparatus and method aimed at reducing the cost of manufacturing irrigation connectors and facilitate product inventory.

### SUMMARY OF THE INVENTION

The invention is a design for a line or inventory of fittings or connectors for agricultural and landscape irrigation use ready made according to individual customer demand comprising a plurality of basic body parts including a common body and termination fittings.

“Common bodies” are defined here to always have two or more joints, which in the preferred embodiment are sonic weld joints. “Termination fittings” always have only one joint on one end and a connector of some type on the other, again preferrably a sonic weld joint. They are of two types of termination fittings: 1) Fitting connectors of various styles for tubing, hose or irrigation tape and, 2) Adapter connectors for threads, barb, hose swivel hub, and socket, to enable a hydraulic connection for a variety of connection types.

Completed fittings made according to the invention are comprised of either two termination fittings or a common body with one or more termination fittings.

The illustrated embodiment shows the common bodies including tees and elbows, but the common body may be any multiple port manifold, such as straight through's, Y's, X's, three dimensional crosses, multiple port stars, triangles, trees, rings or free form manifolds of any topology desired. The common body, however, has at least one outlet that has no means, which can fit into a fluid carrying conduit, such as a hose, irrigation tape or threaded pipe without a termination fittings affixed to the common body

In the illustrated embodiment the termination fittings are generally shown as fitting connectors for hose, tubing or tape in several different styles along with other adapter connectors such as threaded, barbed, socket, hose swivel hub or other style to enable hydraulic connections for a variety of applications.

When the connector style of the two free ends of a sonically welded assembly of two termination fittings are different, such as a threaded adapter end and a hose compression connector, then the completed fitting which is comprised of the combination of the termination fittings without any common body is defined in the present specification as an “adaptor”. When the two ends are the same, it is defined as a “coupling”.

When one or more termination fittings and a common body are sonically welded into an assembly, then the combination is defined in the present specification as a “Tee, Ell or other fitting”. The common body and the termination fittings are collectively defined as “basic parts”.

In the preferred embodiment the basic body parts each have either male or female joints or ports, although universal style port could be easily substituted.

The plurality of basic parts may further include a tee with hub base for female threaded hose swivel; a 0.250″, 0.400″, 0.700″ barbed adapter, a one-half inch pipe spigot adapter, a one-half inch pipe socket adapter, a three-quarter inch pipe socket adapter, and/or a three-quarter inch ball valve body. Again the size choices are a matter of design choice and may be determined according to commercial demand.

The invention is also defined as a method of manufacturing fittings suitable for agricultural and irrigation applications according to ready-made demand comprising the steps of providing a plurality of basic parts having joints or ports, wherein the basic parts may include a tee, a 90 degree elbow, a male tubing connector, and a female tubing connector, among others and assembling the basic parts in various combinations to form a multiplicity of distinct complete connectors, which in the preferred embodiment are sonically welded together.

In summary, the invention is a method of providing an inventory of made-to-demand fittings suitable for agricultural and irrigation applications comprising: the steps is of providing a common body with at least two ports, which ports lack termination fittings; providing selected termination fittings for coupling to the common body or to each other, according to demand; and sonic welding the selected termination fittings to the common body or to each other to form a fluid-tight seal thereto.

In summary, the invention is also defined as a made-to-demand fitting suitable for agricultural and irrigation applications comprising a common body with at least two ports, which ports lack termination fittings; and termination fittings selected according to demand coupled to the common body or to each other to form a fluid-tight seal thereto.

While the apparatus and method has or will be described for the sake of grammatical fluidity with functional explanations, it is to be expressly understood that the claims, unless expressly formulated under 35 USC 112, are not to be construed as necessarily limited in any way by the construction of “means” or “steps” limitations, but are to be accorded the full scope of the meaning and equivalents of the definition provided by the claims under the judicial doctrine of equivalents, and in the case where the claims are expressly formulated under 35 USC 112 are to be accorded full statutory equivalents under 35 USC 112. The invention can be better visualized by turning now to the following drawings wherein like elements are referenced by like numerals.

### BRIEF DESCRIPTION OF THE DRAWING

The objects, advantages and features of the present invention will become more apparent to those skilled in the art from the following detailed description, when read in conjunction with the accompanying drawings, wherein:

FIG. 1 is a perspective view of a distinct complete 90 degree El compression fitting of the present invention wherein a 90 degree elbow is sonic welded to two female compression tubing fitting connectors;

FIGS. 2a and 2b are a side view and an end view of a Tee common body of the present invention;

FIGS. 3a and 3b are a side view and an end view of a 90 degree elbow common body of the present invention;

FIG. 4a is a side view of ½ ″ MPT adapter connector of the present invention;

FIG. 4b is a side view of ¾″ MPT adapter connector of the present invention;

FIG. 4c is a side view of ¾″ MHT adapter connector of the present invention;

FIGS. 5a and 5c are a side view and an end view of a female compression type fitting connector;

FIG. 5b is a side view of a male compression type fitting connector;

FIG. 6a is a side view of a female insert type fitting connector with slide-on tapered ring;

FIG. 6b is a side view of a male insert type fitting connector with a slide-on tapered ring;

FIG. 6c is an end view of the slide-on tapered ring of FIG. 6a;

FIG. 7a is a side view of a female insert type fitting connector with bayonet style twist-on ring;

FIG. 7b is a side view of a male insert type fitting connector with a bayonet style twist-on ring;

FIG. 7c is an end view of the twist-on ring of FIG. 7a;

FIG. 8a is a side view of a distinct complete fitting of the present invention that is a compression type fitting coupling;

FIG. 8b is a side view of a distinct complete fitting of the present invention that is a compression fitting tee;

FIG. 8c is a side view of a distinct complete fitting of the present invention that is a compression fitting elbow;

FIG. 8d is a side view of a distinct complete fitting of the present invention that is a compression adapter ½″ MPT type;

FIG. 8e is a side view of a distinct complete fitting of the present invention that is a compression adapter ¾″ MPT type;

FIG. 8f is a side view of a distinct complete fitting of the present invention that is a compression adapter ¾ MHT type;

FIG. 9a is a side view of a complete fitting of the present invention that is a slide-on ring insert type coupling;

FIG. 9b is a side view of a complete fitting of the present invention that is a slide-on ring insert type tee;

FIG. 9c is a side view of a complete fitting of the present invention that is a slide-on ring insert type elbow;

FIG. 9d is a side view of a complete fitting of the present invention that is a slide-on ring insert adapter ½″ MPT type;

FIG. 9e is a side view of a complete fitting of the present invention that is a slide-on ring insert adapter ¾″ MPT type;

FIG. 9f is a side view of a complete fitting of the present invention that is a slide-on ring insert adapter ¾″ MHT type.

The invention and its various embodiments can now be better understood by turning to the following detailed description of the preferred embodiments which are presented as illustrated examples of the invention defined in the claims. It is expressly understood that the invention as defined by the claims may be broader than the illustrated embodiments described below.

### DETAILED DESCRIPTION OF THE PREFERRED EMBODIMENTS

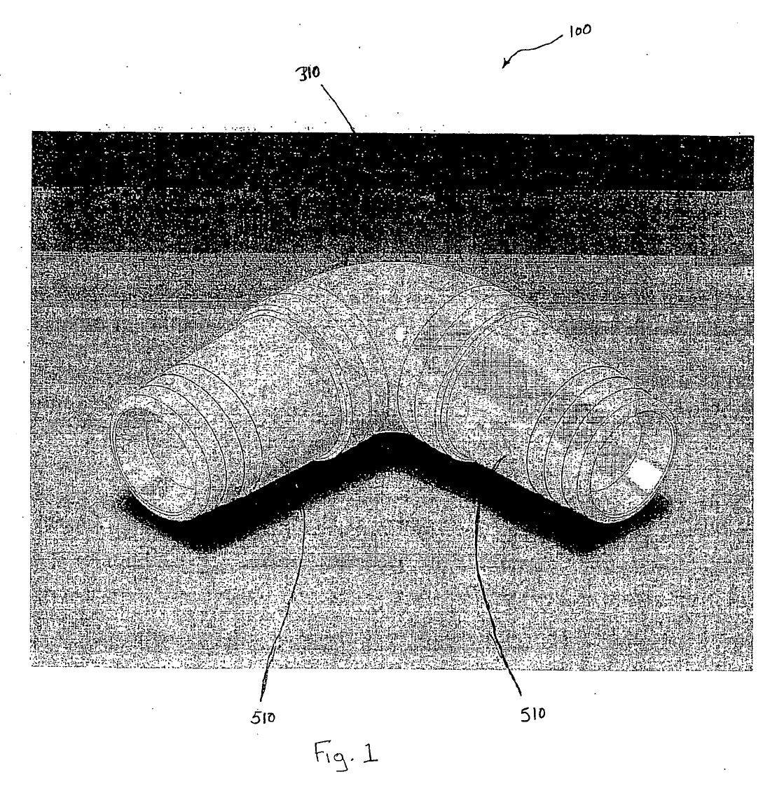

Referring initially to FIG. 1, a distinct complete connector in accordance with the present invention is shown and designated 100, wherein a 90 degree elbow 310 is assembled with two female half-couplings 510. The connector is comprised of three basic parts, as shown. The basic parts of the present invention can be assembled in various combinations to manufacture the connector desired. In a preferred embodiment, the basic parts are joined by sonic welding, a procedure known in the art.

On a first level, the invention contains seven basic parts. More basic parts can be added for different levels of complexity. However, for description purposes, seven basic parts are capable of assembling one family of distinct complete connectors. These seven parts are the following: a T-body part, an elbow basic body part, a ½ inch MPT adapter, a ¾ inch MPT adapter; a three-quarter inch ¾ MHT adapter, a female half-coupling, a male half-coupling, (see FIGS. 2a, 3a, 4a, 4b, 4c, 5a, 5b, respectively). The T-body and elbow are also termed common body parts, herein, and it is envisioned that more common body parts such as wyes and 45 degree elbows could also be common bodies. The seven basic parts are capable of forming twelve distinct connectors and each part is processed using a multi-cavity tool. In prior practice, only eight of the twelve connectors are available from manufactures and each of the eight connectors requires a multi-cavity tool. Thus, the present invention eliminates the need for extra multi-cavity tools and makes additional distinct connectors possible to manufacture. Furthermore, the tools themselves are less complicated, and less expensive.

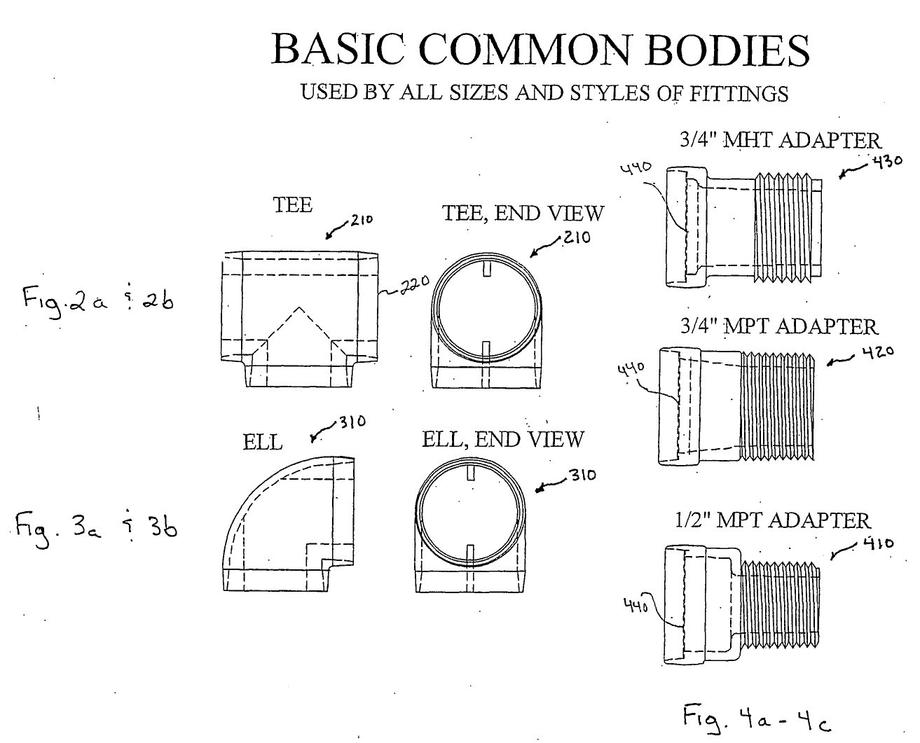

Now referring to FIGS. 2a and 2b, a side view and an end view of a tee basic body part (T-body) 210 are illustrated. The dashed lines represent the inside diameter and other structure not visible from the outside, however, the inside structure is not critical to the present invention. The three joint or port faces 220 are male type. Therefore, to make a complete connector, three other basic parts with female port faces would be required. A tee with female joint faces could be employed as within the scope of the invention. Similar to the tee 210, a 90 elbow basic body part 310 is shown and illustrated in FIGS. 3a and 3b.

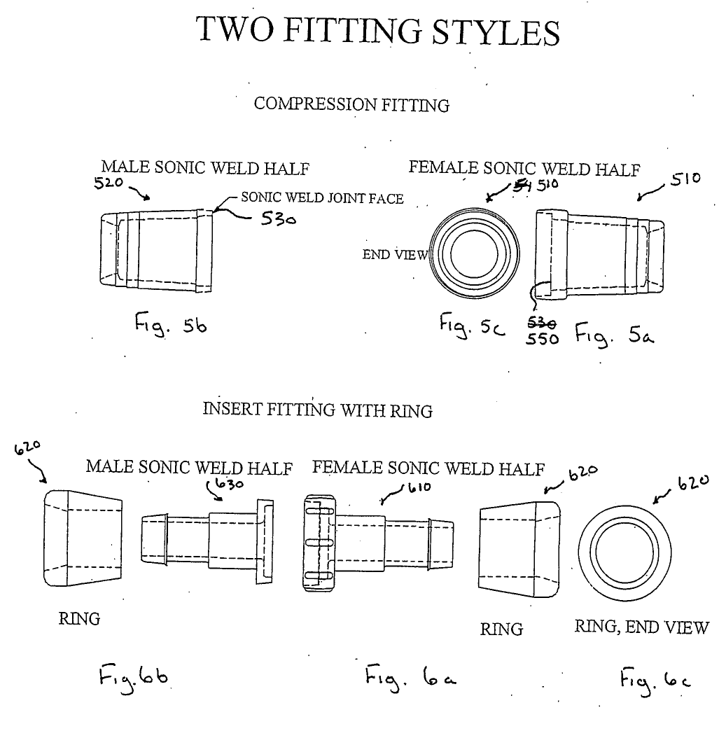

FIGS. 4a through 4c illustrate the threaded adapters that are basic parts of the present invention. They could be employed, for example, to transition from various threaded or glued pipe, tubing or hose ends to commonly used drip connections. The port faces 440 illustrated in FIGS. 4a through 4c are female type, so the adapters 410, 420, 430 could be assembled to an elbow 310 or tee 210 basic body part. Additionally the adapters 410, 420, 430 could be combined with a male half-coupling 520 (see FIG. 5b) to form a complete connector.

FIGS. 5a and 5b illustrate the final two of a total of seven basic parts at this level of the invention that are a female half-coupling 510 and a male half-coupling 520. The male and female sonic weld joint faces 530, 550 are shown. FIG. 5c shows an end view of female half-coupling 510. The couplings 510, 520 are compression type as is known in the art.

On a second level, more basic parts may be added to the present invention to accommodate different connector styles. More specifically, if insert type male and female half couplings 630 and 610 are added the basic parts, a total of twenty-four connectors can be made from nine basic parts. The twenty-four connectors can be manufactured with nine multi-cavity tools. Under the current manufacturing scenario, sixteen multi-cavity tools would be required to make sixteen distinct connectors. Stated differently, since eight multi-cavity tools make a line of eight connectors of one style, sixteen tools are needed for sixteen connectors of two different styles. FIGS. 6a and 6b illustrate male and female half couplings 630, 610 that are insert type with a slide-on tapered ring 620.

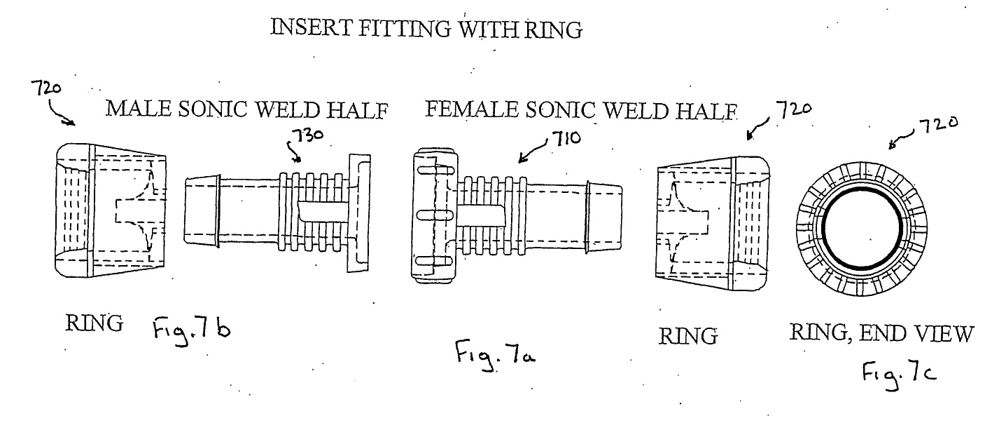

Referring to FIGS. 7a through 7c, female and male half couplings 710, 730 are shown that are insert type with bayonet style twist-on ring 720. The ring 720 provides a secure grip for tubing. If female and male sonic weld halves 710 and 730 are added to the nine basic parts previously described, a total of eleven parts can make thirty-six complete connectors and, thus, greatly simplify the current manufacturing process.

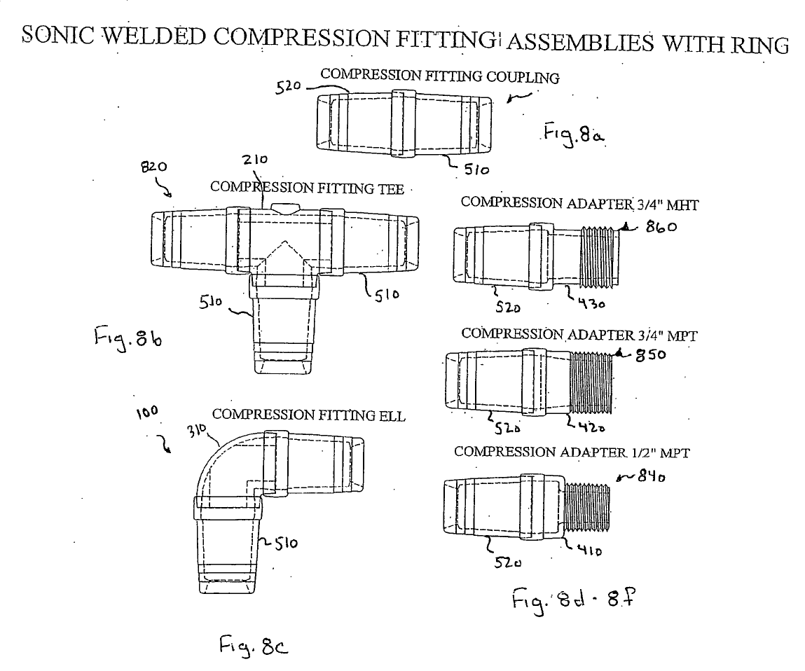

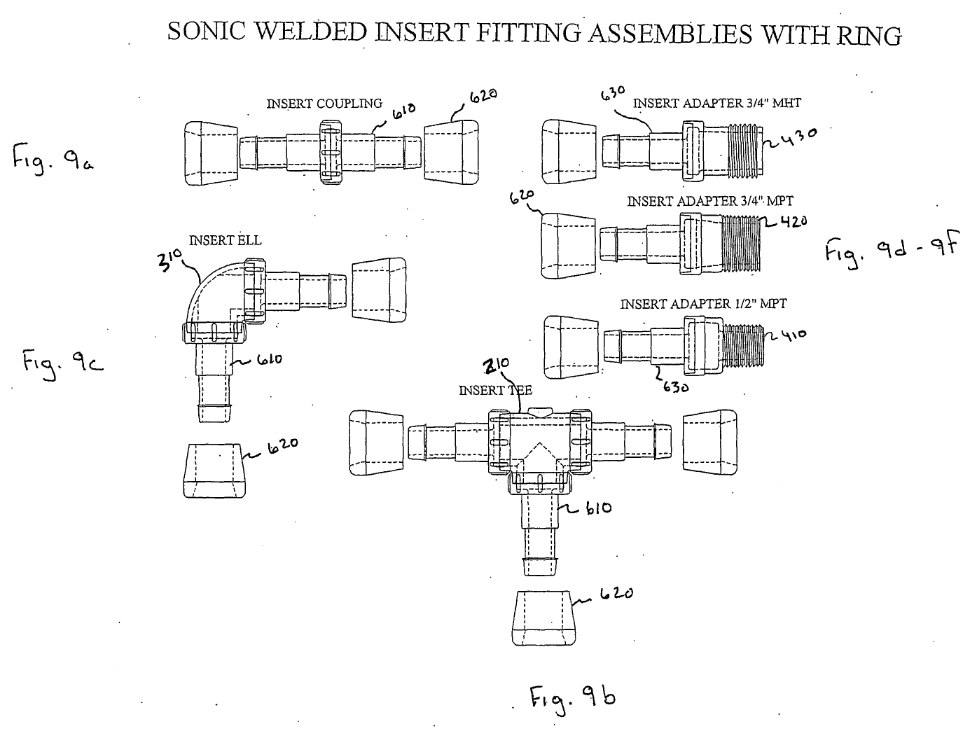

FIGS. 8a through 8f illustrate six complete distinct connectors of the present invention. Each are compression type fittings. More combinations can be made by assembling adapters 410, 420, 430, with a tee 210 or an elbow 310.

Thus far, three different styles of fittings have been disclosed for the present invention that total thirty-six distinct fittings. Taking this concept a step further, if three sizes of fittings were to be offered for each style of fitting, twelve additional multi-cavity tools for a-total of twenty-three would be all that are required. These twenty-three tools would be able to produce one hundred eight distinctive fittings. Under the current manufacturing scenario, only seventy-two fittings of these sizes and styles are available and those require seventy-two multi-cavity tools to manufacture.

The inventive aspect disclosed herein can be expanded even further by adding more basic parts and more fitting styles. Specifically contemplated additional basic parts are: a tee with hub base for female threaded hose swivel, a 0.250″ barbed adapter, a 0.400″ barbed adapter, a 0.700″ barbed adapter, a one-half inch pipe spigot adapter, a one-half inch pipe socket adapter, a three-quarter inch pipe socket adapter, and a three-quarter inch ball valve body.

Additional contemplated fitting styles, each employing sonic welded joints in a preferred embodiment include: insert type with no ring for tubing in low pressure applications, insert type with thread-on ring for tubing, insert type with male threads and internal threaded ring for tubing or irrigation tape.

In summary, tremendous advantages to irrigation fitting manufacturing can be achieve by using devices and methodology of the present invention. Importantly, fewer numbers of complex multi-cavity tools are required to manufacture fitting lines of various sizes and styles. The ability to assemble a wide variety of complete fittings from a relatively low number of individual parts by sonic welding greatly assists inventory management of all parts and fittings. Further, fewer mold presses are required and much less changeover and set-up time is needed in making less parts, therefore making molding scheduling much easier. Also an advantage is that order response time is much faster and the fittings can be assembled with automated or semi-automated sonic welding equipment. Overall, the cost of producing fittings is much less and the business easier to manage. While sonic welding is the preferred method of joining the basic parts, it is also expressly contemplated that any other method of joining now known or later devised may also be employed, such as adhesively or solvent bonding, press fitting, or any type of mechanical attachment by threaded or interlocking surfaces. Thus, it is not necessary to have male and female versions of the termination fittings, but as stated above they may have a universal design and be butt welded or joined together. The male-female combinations are preferred as avoiding the appearance of and any possible misalignment or interference from flash.

Many alterations and modifications may be made by those having ordinary skill in the art without departing from the spirit and scope of the invention. Therefore, it must be understood that the illustrated embodiment has been set forth only for the purposes of example and that it should not be taken as limiting the invention as defined by the following claims. For example, notwithstanding the fact that the elements of a claim are set forth below in a certain combination, it must be expressly understood that the invention includes other combinations of fewer, more or different elements, which are disclosed in above even when not initially claimed in such combinations.

The words used in this specification to describe the invention and its various embodiments are to be understood not only in the sense of their commonly defined meanings, but to include by special definition in this specification structure, material or acts beyond the scope of the commonly defined meanings. Thus if an element can be understood in the context of this specification as including more than one meaning, then its use in a claim must be understood as being generic to all possible meanings supported by the specification and by the word itself.

The definitions of the words or elements of the following claims are, therefore, defined in this specification to include not only the combination of elements which are literally set forth, but all equivalent structure, material or acts for performing substantially the same function in substantially the same way to obtain substantially the same result.

In this sense it is therefore contemplated that an equivalent substitution of two or more elements may be made for any one of the elements in the claims below or that a single element may be substituted for two or more elements in a claim. Although elements may be described above as acting in certain combinations and even initially claimed as such, it is to be expressly understood that one or more elements from a claimed combination can in some cases be excised from the combination and that the claimed combination may be directed to a subcombination or variation of a subcombination.

Insubstantial changes from the claimed subject matter as viewed by a person with ordinary skill in the art, now known or later devised, are expressly contemplated as being equivalently within the scope of the claims. Therefore, obvious substitutions now or later known to one with ordinary skill in the art are defined to be within the scope of the defined elements.

The claims are thus to be understood to include what is specifically illustrated and described above, what is conceptionally equivalent, what can be obviously substituted and also what essentially incorporates the essential idea of the invention.

I claim:

1. A design for agricultural and landscape irrigation fittings ready made according to demand comprising:
a plurality of basic parts including:
a common body; or
a plurality of different types of termination fittings;
wherein the plurality of basic parts can be assembled together in various combinations to form a multiplicity of distinct complete connectors.

2. The design of claim 1, wherein said common body has one or more variations including:
a T-body;
a 90 degree elbow body;
a swivel hose body; or
a ball valve body.

3. The design of claim 1, wherein the plurality of basic parts further include:
a one-half inch MPT termination fitting;
a three-quarter inch MPT termination fitting; or
a three-quarter inch MHT termination fitting.

4. The design of claim 1, wherein the common body has male ports.

5. The design of claim 1, wherein the plurality of basic parts are assembled by sonic welding.

6. The design of claim 1, wherein the plurality of basic parts further include:
a tee with hub base for female threaded hose swivel;
a 0.250″ barbed termination fitting;
a 0.400″ barbed termination fitting;
a 0.700″ barbed termination fitting;
a one-half inch pipe spigot termination fitting;
a one-half inch pipe socket termination fitting;
a three-quarter inch pipe socket termination fitting; or
a three-quarter inch ball valve body.

7. The design of claim 1 wherein the termination fittings are a compression type for tubing.

8. The design of claim 1 wherein the termination fittings are an insert type.

9. A method of manufacturing fittings according to individual customer demand suitable for agricultural and irrigation applications comprising the steps of:
providing a plurality of basic parts including a common body, and a plurality of termination fittings; and
assembling the basic parts in various combinations to form a multiplicity of distinct complete connectors.

10. The method of manufacturing connectors as in claim 9 and further comprising the step of sonic welding the basic parts together.

11. The method of manufacturing connectors as in claim 9 wherein the common body has one or more variations including a T-body, an elbow body, a swivel hose body, or a ball valve body.

12. The method of manufacturing connectors as in claim 9 and further comprising the step of providing additional basic parts including a tee with hub base for female threaded hose swivel, a 0.250″ barbed termination fitting; a 0.400″ barbed termination fitting, a 0.700″ barbed termination fitting, a one-half inch pipe spigot termination fitting, a one-half inch pipe socket termination fitting, a three-quarter inch pipe socket termination fitting; or a three-quarter inch ball valve body.

13. The method as in claim 9 wherein the assembling step is performed using sonic welding.

14. A method of providing an inventory of made-to-demand fittings suitable for agricultural and irrigation applications comprising:
providing a common body with at least two ports, which ports lack termination fittings or selected termination fittings for coupling to the common body according to demand; and
coupling the selected termination fittings to the common body or the selected termination fittings together to form a fluid-tight seal between them and to provide a completed connector according to demand.

15. The method of claim 14 where providing the common body comprises selectively providing a T-body, elbow body, swivel hose body, or ball valve body according to demand.

16. The method of claim 14 where providing selected termination fittings according to demand comprises selectively providing threaded, barbed or spigot termination fittings of selected sizes, hose swivel fittings of selected sizes, pipe socket termination fittings of selected sizes, ball valve bodies of selected sizes, or tubing compression or insert-type termination fittings, each according to demand to couple to the common body.

17. The method of claim 14 where providing the common body provides a body with ports of a first one of a male or female type, and where providing selected termination fittings for coupling to the common body according to demand provides termination fittings of a second one of a male or female type, opposite the first type.

18. The method of claim 17 where providing a common body with ports of a first one of a male or female type comprises providing a common body with male type ports, and where providing termination fittings of a second one of a male or female type comprises providing termination fittings of a female type.

19. A made-to-demand fitting suitable for agricultural and irrigation applications comprising:
a common body with at least two ports, which ports lack termination fittings; and
termination fittings selected according to demand coupled to the common body to form a fluid-tight seal thereto.

20. The fitting of claim 19 where the common body comprises a multiple port manifold selected according to demand.

21. The fitting of claim 19 where the selected termination fittings comprises threaded, barbed or spigot termination fittings of selected sizes, hose swivel termination fittings of selected sizes, pipe socket termination fittings of selected sizes, ball valve bodies of selected sizes, or tubing compression or insert-type termination fittings, each selected according to demand.

22. The fitting of claim 19 where the common body has ports of a first one of a male or female type, and where the selected termination fittings for coupling to the common body have a second one of a male or female type, opposite to the first type.

23. The fitting of claim 22 where the ports are male type ports, and the termination fittings are of a female type.

24. A made-to-demand fitting suitable for agricultural and irrigation applications as an adapter comprising:
a male termination fitting of a first type selected according to demand; and
a female termination fitting of a second type different from the first type selected according to demand, the male and female termination fittings being coupled together to form a fluid-tight seal thereto.

25. The fitting of claim 24 where the first type of fittings is a compression fitting and where the second type of fitting is an insert fitting.
